(19) United States
(12) Patent Application Publication
(10) Pub. No.: US 2007/0212143 A1
(43) Pub. Date: Sep. 13, 2007

(54) Print management apparatus, recording medium, and print management method

(76) Inventor: Hiromi Ohara, Kawasaki-shi (JP)

Correspondence Address: GAUTHIER & CONNORS, LLP, 225 FRANKLIN STREET, SUITE 2300, BOSTON, MA, 02110, US

(21) Appl. No.: 11/487,214

(22) Filed: Jul. 14, 2006

(30) Foreign Application Priority Data
Mar. 2, 2006 (JP) 2006-56116

(51) Int. Cl. B41J 5/30

(52) U.S. Cl. 400/62

(57) ABSTRACT

A print management apparatus includes a print command unit that transmits print command data and prints a print image onto a paper sheet on the basis of print data, an acquisition unit that acquires generated scan data from a scan of the paper sheet printed with the print image, a setting unit that sets a part of the print image as an inspection area on the basis of the print data, and an inspection unit that inspects for printing discrepancies by comparing the scan data and the print data in the set inspection area.

### BACKGROUND

1. Technical Field

The present invention relates to a technology for inspecting printed results, and more particularly to a technology for performing inspections by comparing scan data from a scan of a printed result and print data to be used in printing.

2. Related Art

The need for creating printed matter targeted at individuals, such as travel pamphlets, direct mail, and bills, is recently increasing. In this type of printing, so that the printed content differs in the printed matter for each individual, mechanically inspecting whether or not the printing was appropriate is difficult and the inspection often relies on human effort.

### SUMMARY

According to an aspect of the invention, a print management apparatus includes a print command unit that transmits print command data and prints a print image onto a paper sheet on the basis of print data, an acquisition unit that acquires generated scan data from a scan of the paper sheet printed with the print image, a setting unit that sets a part of the print image as an inspection area on the basis of the print data, and an inspection unit that inspects for printing discrepancies by comparing the scan data and the print data in the set inspection area.

### BRIEF DESCRIPTION OF THE DRAWINGS

Embodiments of the present invention will be described in detail based on the following figures, wherein:

FIG. 1 exemplifies a general configuration of a printing system;

FIG. 2 illustrates a configuration of a variable system;

FIG. 3 illustrates a modified example of the printing system configuration;

FIG. 4 illustrates another modified example of the printing system configuration;

FIG. 5 is a sequence chart illustrating the processing flow in the printing system;

FIG. 6 is a flowchart illustrating the operational flow at a user terminal;

FIG. 7 is a flowchart illustrating the processing flow of the variable system;

FIG. 8 is a sequence chart illustrating a modified example of processing in the printing system; and

FIG. 9A, FIG. 9B, and FIG. 9C show examples of printed results.

### DETAILED DESCRIPTION

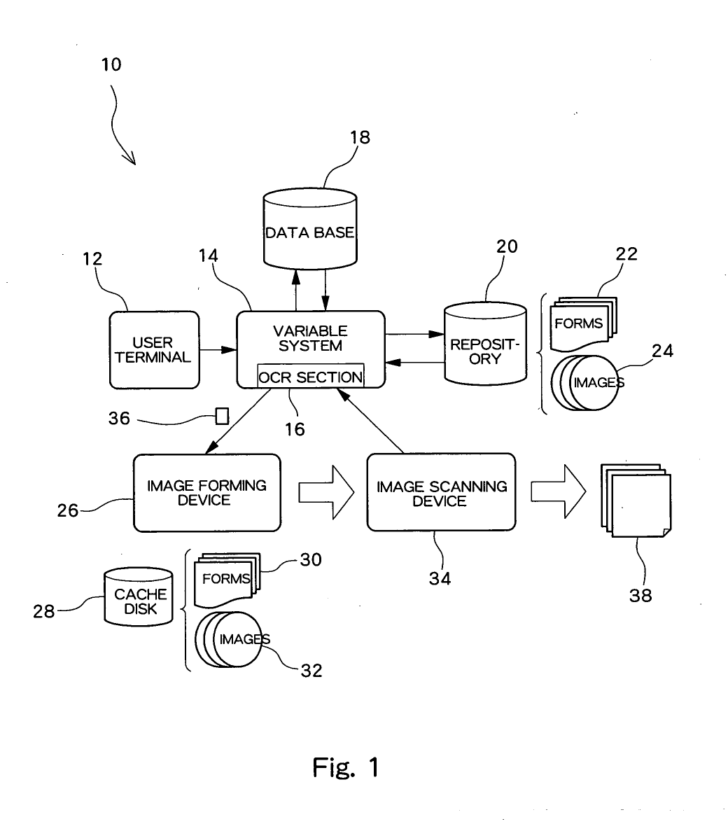

FIG. 1 illustrates a general configuration of a printing system 10 relating to the embodiment. The printing system 10 includes as main components a user terminal 12, a variable system 14, a database 18, a repository 20, an image forming device 26, and an image scanning device 34.

The user terminal 12 is a terminal device for operating the variable system 14 and is configured using a PC (Personal Computer) or one of various network machines. The user terminal 12 may operate according to user operation or on the basis of software. The user terminal 12 issues ordinary print commands and variable print commands to the variable system 14.

The variable system 14 plays a central role in the management of the overall system and is constructed using a PC or an image forming device. The variable system 14 executes commands that are input from the user terminal 12 so that the various components of the printing system 10 perform processing. For example, if a variable print command is issued from the user terminal 12, the variable system 14 acquires a form 22 or an image 24 stored in the repository 20 as well as searches the backend database 18 for data to be substituted into a variable part of the acquired form 22 and composes them to create a digital document or print data. Here, the form 22 is template data and the image 24 is data expressed in raster form. The variable system 14 then transmits the created digital document and a job ticket or print command data to the image forming device 26 and manages them as a print job. In this manner, the variable system 14 typically creates all the completed pages of the digital document on demand and transmits them to the image forming device 26. However, the completion of the digital document can also be performed by the image forming device 26 and not by the variable system 14. More specifically, by caching the forms 22 and images 24 required to create the digital document into the image forming device 26 and performing a command for substituting data into the variable parts from the variable system 14 to the image forming device 26, a mode can be given for completing the digital document in the image forming device 26.

The variable system 14 further receives scanned data (generally an image) of a printed result from the image scanning device 34 and with the scanned data as a mask on the form 22 used for printing, the scanned data in the vicinity of the variable part is extracted. Thus, the form 22 is managed by association with the print job. The variable system 14 is provided with an OCR (Optical Character Reader) section 16 and the extracted scanned data is converted to character codes by the OCR section. This result is compared with the data that was found from the database 18 during the creation of the digital document and inspected to determine whether or not printing was performed properly. Instead of performing OCR processing for the inspection, the similarity with the original image may be compared. As a result of the inspection, if it is judged that is a discrepancy in the printing, a warning is issued to the user terminal 12 and the printing process is interrupted.

Data to be substituted into the variable part of the form 22 stored in the repository 20 is managed in the database 18. When a condition for the data to be substituted into the variable part is set, the database 18 is searched and data satisfying the condition is transmitted to the variable system 14.

The repository 20 is a device composed from a storage device, such as a hard disk, and stores forms 22 and images 24 attached to the forms 22. The repository 20 may be constructed from multiple storage devices.

The image forming device 26 receives a print command 36 from the variable system 14 and prints onto a paper sheet. It may be configured from a variety of printers or multifunction machines having printer functions. The print command 36 includes a job ticket that indicates print settings and a digital document to be printed. As described above, the digital document is typically formed from data in which all pages are complete. However, the digital document may also be configured from multiple data items forming page components and data defined by the assembly method for these data items. A mode can be given for the latter example for performing printing by caching forms 30 and images 32 as components into a cache disk 28 provided in the image forming device 26 and then receiving print format data defining their assembly method.

The image scanning device 34 scans and converts a printed result that is output by the image forming device 26 into digital data. The scanning device 34 is configured from a scanner or a multifunction machine having a scanning function. The created scan data is transmitted to the variable system 14. The transmitted scan data is used in the variable system 14 for inspection. As a result, if a printing discrepancy is not detected, a printed matter 38 is output.

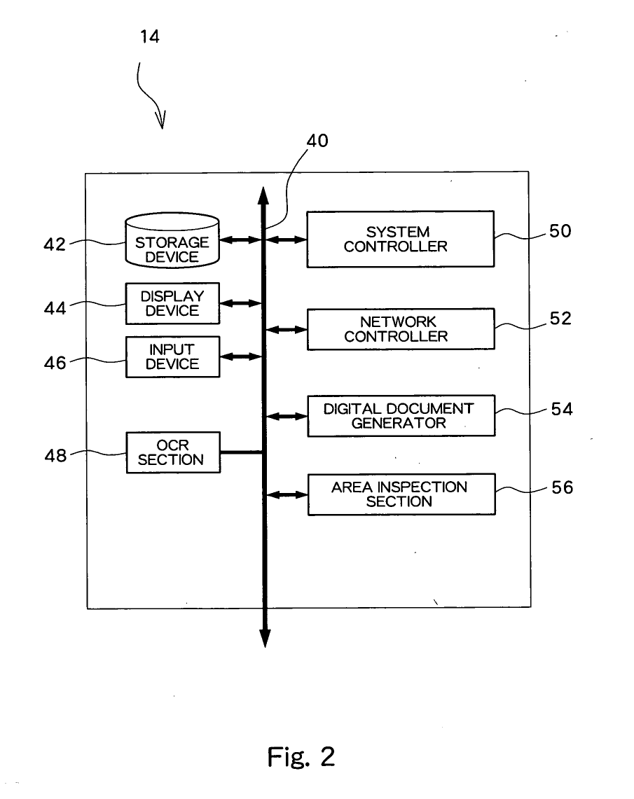

FIG. 2 exemplifies a configuration of the variable system 14. A network 40 is provided in the variable system 14 for performing data transfers internally and externally. In the network 40 are connected a storage device 42, a display device 44, an input device 46, an OCR section 48, a system controller 50, a network controller 52, a digital document generator 54, and an area inspection section 56.

The storage device 42 is formed from semiconductor memory or a hard disk and performs short-term or long-term storage of digital documents or programs. The display device 44 is formed from a liquid crystal display or a CRT display and performs the display of digital documents or commands. Furthermore, the input device 46 is formed from a keyboard or a touch panel and accepts commands from users. The OCR section 48 is a device for converting the scan data that is input from the image scanning device 34 into character codes.

The system controller 50 accepts a command that is input from the input device 46 or a command that is input from the user terminal 12 via the network 40 and controls the operation of the various components of the variable system 14. The network controller 52 controls the data transfer timing to the network 40. The digital document generator 54 generates a new digital document by using the form 22, image 24, and data in the database 18. Furthermore, the area inspection section 56 generates data for inspection by masking the scan data with the form 22 and converts it into character data with the OCR section 48. At this time, the mask mode is determined by referencing data to control printing, such as double-sided printing, N-up printing (data for N pages is printed on one page), and rotation printing. The area inspection section 56 compares the character data obtained by the OCR section 48 with the corresponding data in the database 18 and inspects for any discrepancies in the printing. Another inspection, such as the detection of smudges in the overall scan data, can also be adopted in the variable system 14 besides the inspection by the area inspection section 56.

The various components of the printing system 10 shown in FIG. 1 and FIG. 2 can be packaged in a variety of ways. For example, the printing system 10 can be constructed using one high-performance multifunction machine, or using multiple PCs and multifunction machines directly connected or connected via a network. Furthermore, an arbitrary component can be distributed among multiple devices, such as by distributing the installation of the repository 20 among multiple storage devices, for example.

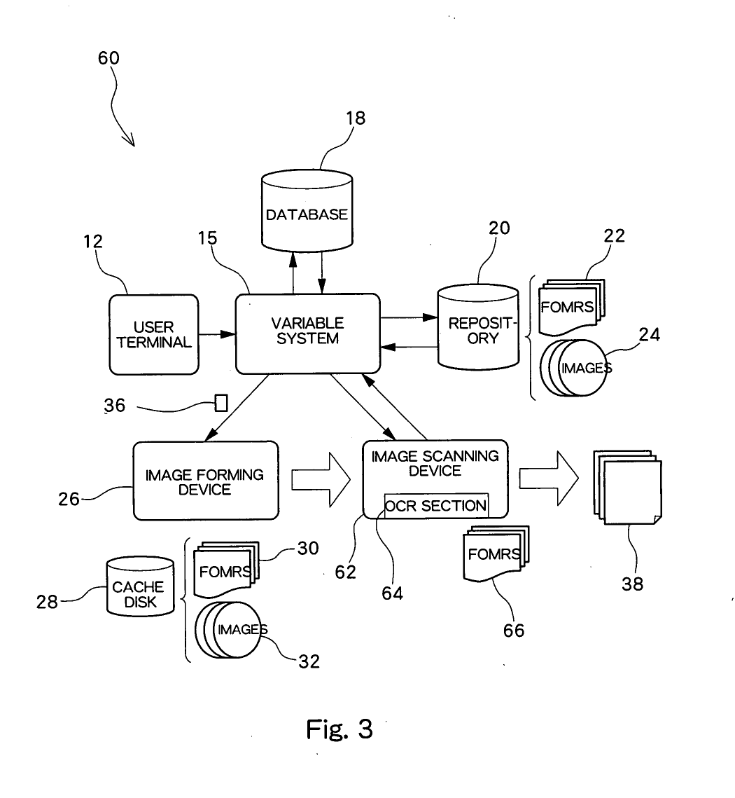

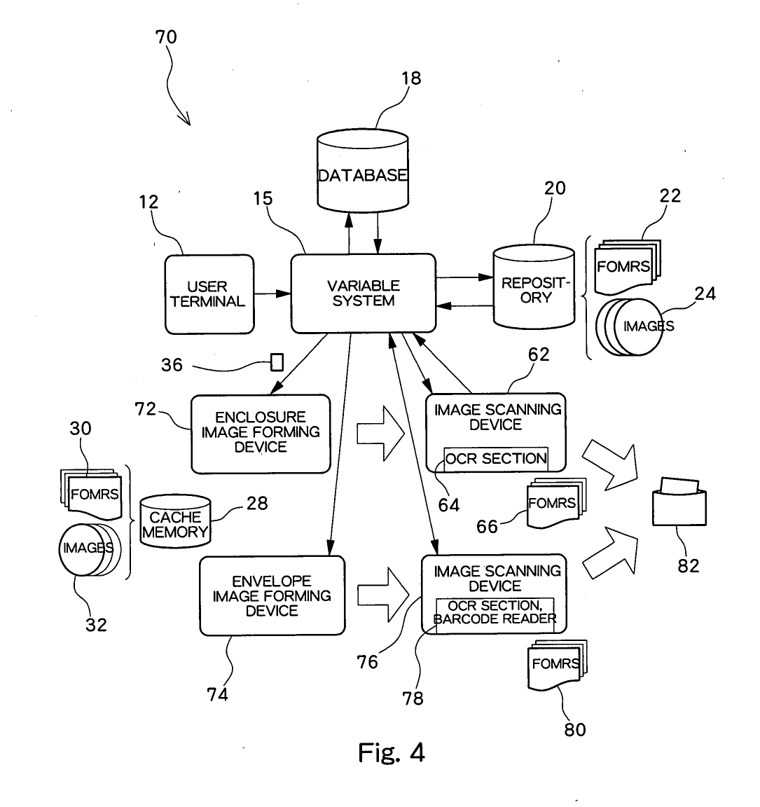

A modified example of the printing system 10 shown in FIG. 1 will be described briefly with reference to FIG. 3 and FIG. 4. Components in the figures identical to the components in FIG. 1 are designated like reference characters and their descriptions are simplified.

The major difference between a printing system 60 shown in FIG. 3 and the printing system 10 shown in FIG. 1 is the provision of a variable system 15 and an image scanning device 62 instead of the variable system 14 and the image scanning device 34. Namely, the printing system 60 has the variable system 15, which is not provided with an OCR section, and the image scanning device 62, which is provided with an OCR section 64. At the image scanning device 62, the scan data created from scanning a printed result is converted into character codes by the OCR section 64. At this time, a form 66 used during digital document generation is received from the variable system 15 and used as a mask for the scan data.

A printing system 70 shown in FIG. 4 further modifies the printing system 60 shown in FIG. 3. In the printing system 70, printing to an envelope and printing to an envelope enclosure are performed, after which the mapping of both are inspected and a process is further performed to insert the enclosure into the envelope. Thus, in the printing system 70, an enclosure image forming device 72 and an envelope image forming device 74 are provided instead of the image forming device 26 in the printing system 60, and an image scanning device 76 is further provided for scanning the printed result for the envelope. Namely, the enclosure is printed by the enclosure image forming device 72 and undergoes scanning and OCR processing by the image scanning device 62. As a result, the inspection of printing discrepancies for enclosures becomes possible in the variable system 15.

Envelope printing is performed by the envelope image forming device 74 and scanning of the printed result is performed by the image scanning device 76. The image scanning device 76 is provided with an OCR and barcode reader 78 to achieve character code conversion on a masked result with a form 80 and to read and confirm barcodes corresponding to a printed address. As a result, the variable system 15 makes it possible to inspect the printing on envelopes for discrepancies. If there are no discrepancies in the enclosure and envelope and if both have been properly mapped, an automatic enclosure is performed to create a sealed letter 82.

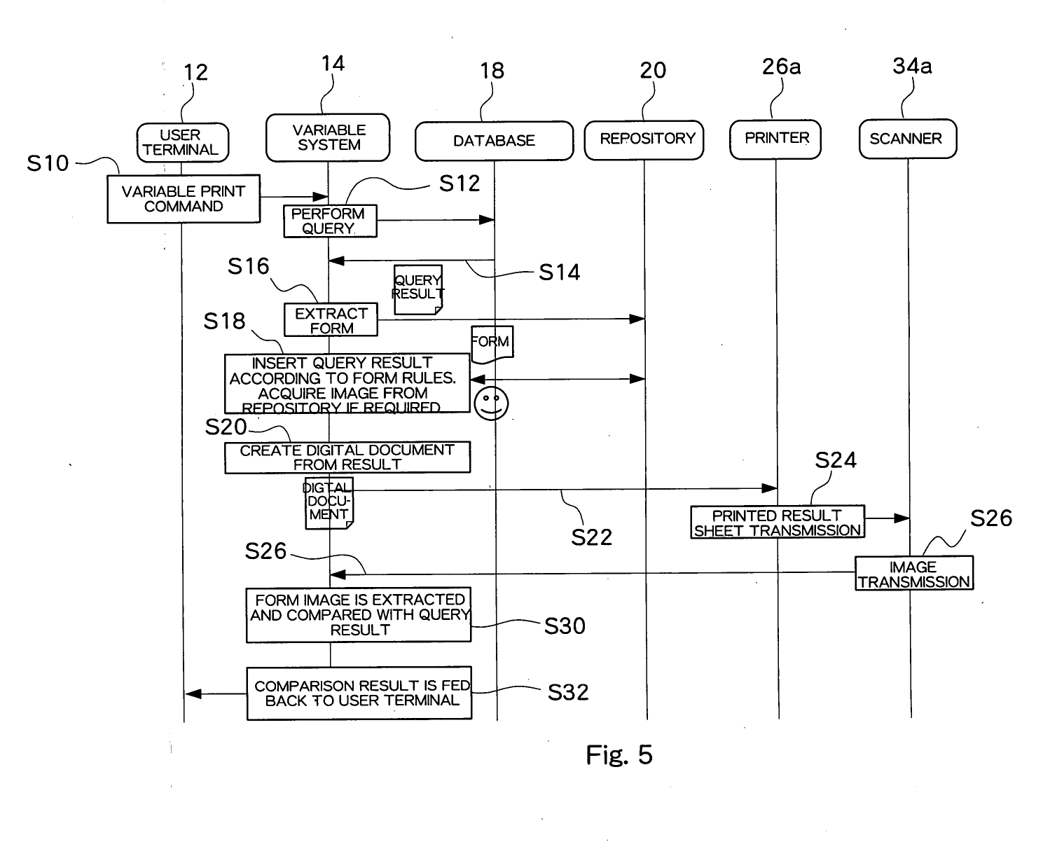

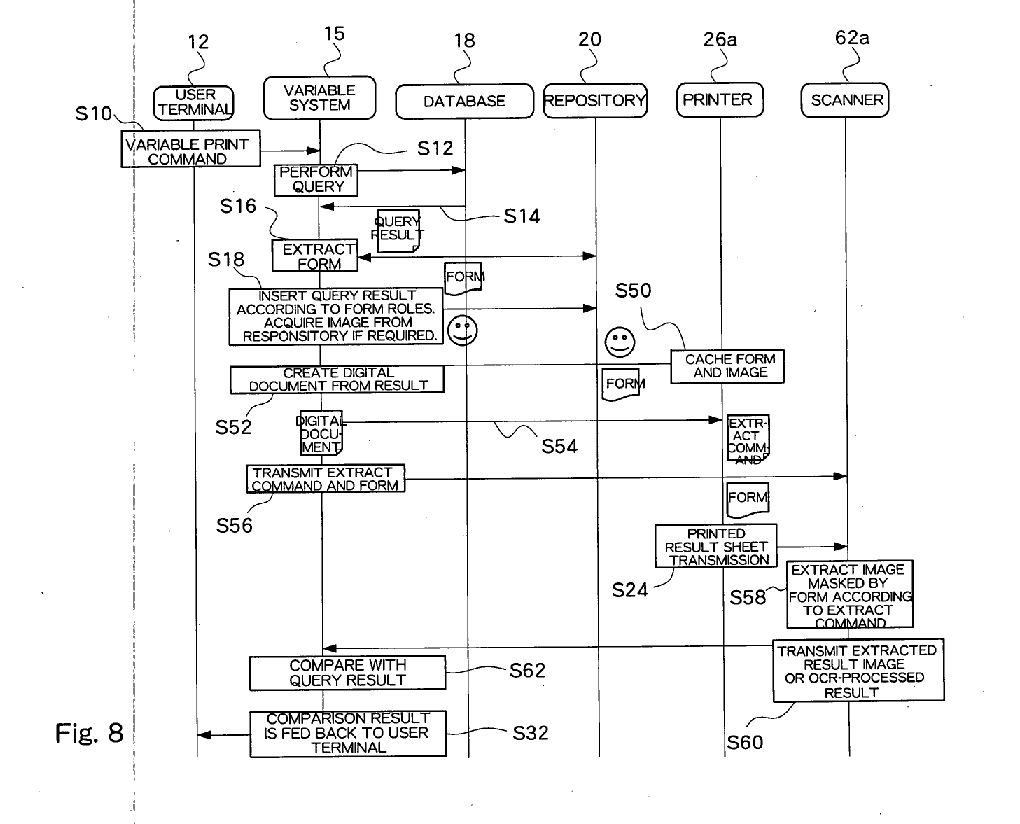

Operations of the printing systems will be described next with reference to FIGS. 5 to 8. FIGS. 5 to 7 illustrate the operation of the printing system 10 shown in FIG. 1 and FIG. 8 illustrates the operation of the printing system 60 shown in FIG. 3.

FIG. 5 is a sequence chart illustrating the digital document generation, printing, and inspection processes in the printing system 10. The sequence of processes is shown by designating the major processes of the user terminal 12, the variable system 14, the database 18 and the repository 20 shown in FIG. 1 as well as a printer 26a for the image forming device 26 and a scanner 34a for the image scanning device 34 shown in FIG. 1.

The user terminal 12 instructs variable printing to the variable system 14. At this time, a form defining the format of the digital document to be created and the search conditions for the data to be substituted into the form are specified and print control conditions, such as double-sided printing, N-up printing, reduction and enlargement printing, are further set.

The variable system 14 performs an inquiry (S12) to the database 18 on the basis of the input search condition and acquires corresponding data (S14). Furthermore, a specified form is acquired (S16) from the repository 20 and the data is substituted. If necessary in this process, the image 24 is suitably acquired (S18) from the repository 20. In this manner, the digital document is created (S20) as print data.

The created digital document is transmitted (S22) to the printer 26a together with the print control condition that was input from the user terminal 12. The printer 26a then prints the digital document to a paper sheet and sends the printed sheet (S24) to the scanner 34a. The scanner 34a scans this paper sheet, then generates scan data and transmits the data (S26) to the variable system 14. At the variable system 14, only the data corresponding to the variable part is extracted by masking the received scan data with the form used during creation of the digital document and converted to character codes by the OCR. The obtained character codes are sent to the variable system 14 and compared (S30) with the data used in the creation of the digital document. As a result, if they match, it is determined that printing was performed correctly. If they do not match, it is determined that there is a printing discrepancy, and a notification of which is sent (S32) to the user terminal 12.

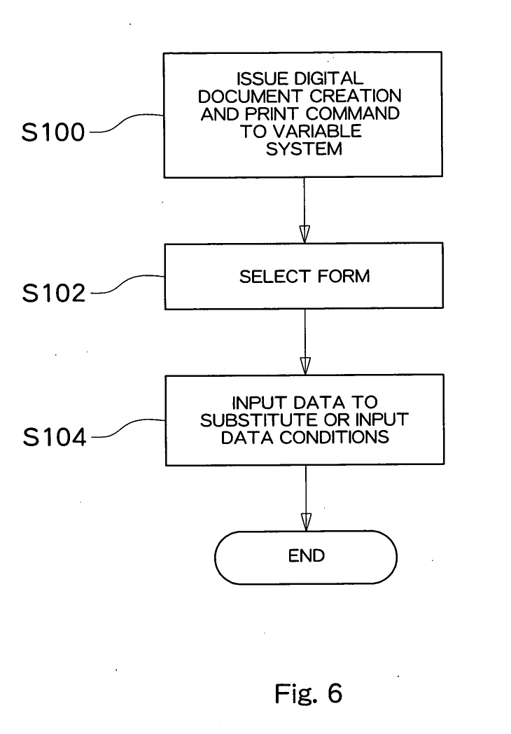

Next, the flow of commands of the user terminal 12 in the processes shown in FIG. 5 will be confirmed using the flowchart of FIG. 6. The user terminal 12 first issues a request to create and print a digital document (S100) to the variable system 14 and selects a desired form (S102) from the available forms. Then, data is directly input to the variable part of the form or conditions for inputting data from the database 18 are set (S104) . As a result, the digital document is created and printed in the variable system 14. Naturally, the user terminal 12 may perform the print request after the digital document is created.

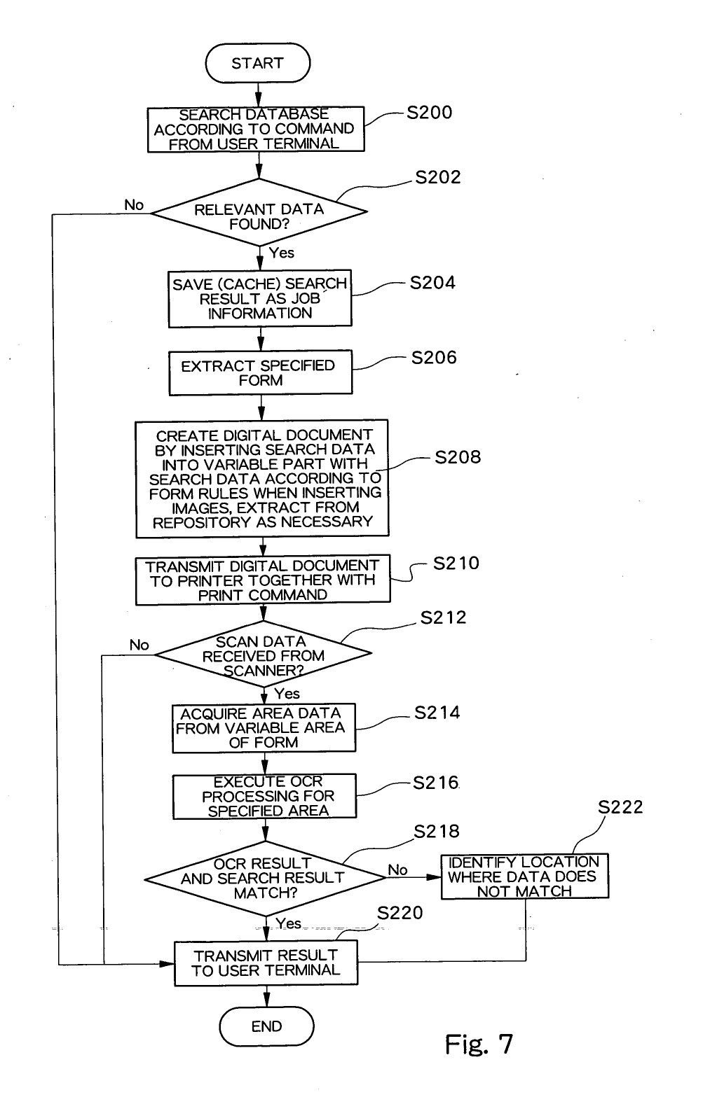

The flowchart of FIG. 7 shows the processing flow of the variable system 14 in the processes shown in FIG. 5. If a digital document creation and print request is issued from the user terminal 12, the variable system 14 searches the database 18 for data and investigates whether or not data satisfying the conditions is found (S200). As a result, if data is not found, a notification of which is transmitted to the user terminal 12 and the process terminates (S220). If data is found, the data is acquired and stored or cached (S204). Next, the specified form is fetched from the repository 20, and in accordance with the rules of that form, data is inserted into the variable part of the form to create the digital document. If the data to be inserted into the form is an image, the data is fetched from the repository as necessary and inserted into the form (S208).

The created digital document is transmitted (S210) to the printer together with the print command and printed on a paper sheet. Then, scan data created from the scan of the scanner is transmitted to the variable system 14. At the variable system 14, it is investigated (S212) whether or not the scan data has been received within an appropriate time. If the scan data is not received, a notification of which is sent to the user terminal 12 and the process terminates (S220). On the other hand, if the scan data is received, the data (relating to position, size, and so forth) indicating the variable part area of the form used in the creation of the digital document is acquired (S214), the area for OCR processing is determined, and OCR processing is executed (S216) . The obtained character codes, for example, are then compared (S218) with the cached data. If they match, a notification of the match is sent to the user terminal and the process terminates (S220). If they do not match, the location where the data does not match is identified (S222) and notified to the user terminal 12 (S220).

Next, the processing flow corresponding to the configuration of FIG. 3 will be described using the sequence chart of FIG. 8. In FIG. 8, the components and processes identical to those in FIG. 5 are designated like reference characters and their descriptions will be omitted. In the processing of FIG. 8, the variable system 15 does not completely create the digital document and transmits the necessary form and images to the printer 26a, wherein they are cached (S50, S52). Furthermore, the variable system 15 transmits a print command and print format data to the printer 26a. As a result, printing can be executed (S54) while the digital document is assembled at the printer 26a. Furthermore, the variable system 15 transmits the form to the scanner 62a and performs an extract command for the area corresponding to the variable part (S56). In accordance with this command, the scanner 62a masks the scan data generated from the printed result using the form, extracts (S58) the data corresponding to the variable part, and performs OCR processing as necessary. Then, the extracted result or the corresponding OCR processing result is transmitted (S60) to the variable system 15. At the variable system 15, this result is first compared (S62) with a result of searching from the database 18 and a notification of the comparison result (S32) is sent to the user terminal 12.

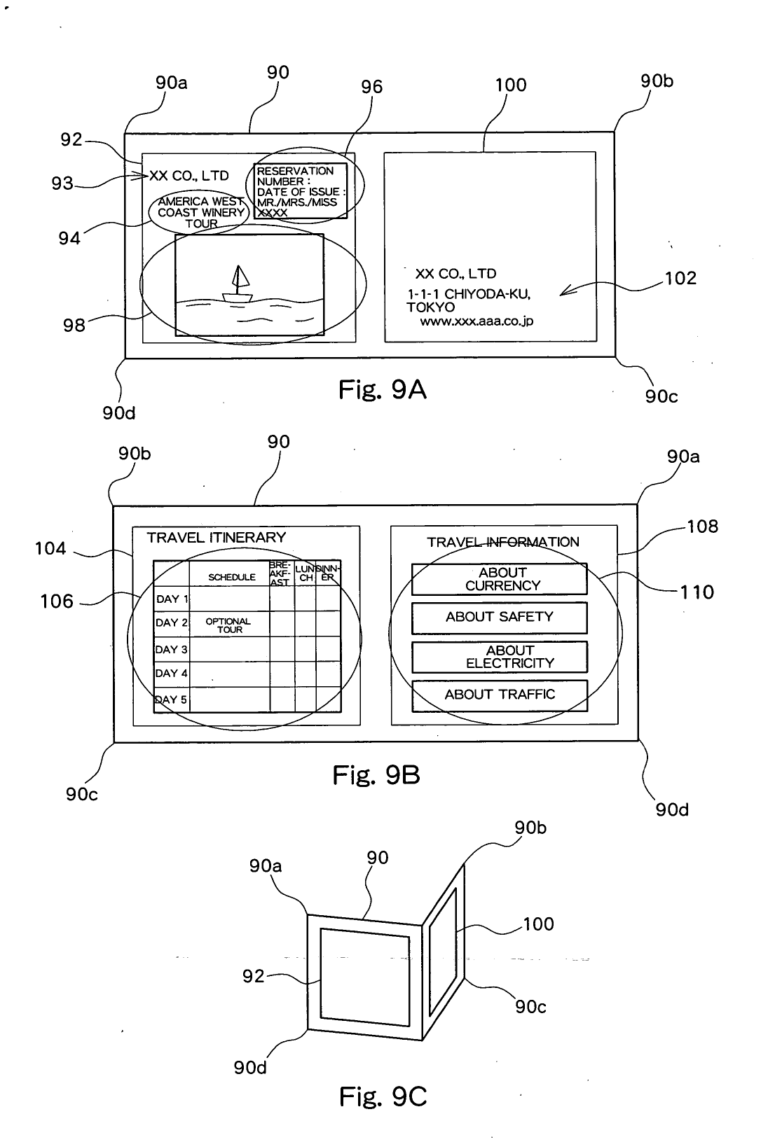

Finally, a specific digital document will be illustrated. FIG. 9 shows a state where a four-page digital document, which is created from a form, is printed two-pages per side on a paper sheet 90. The digital document includes data created by a tour company for individual customers who have applied for a tour and is created as a travel pamphlet for the individual customers in booklet form by folding the printed paper sheet 90 into two.

In FIG. 9A are depicted documents 92, 100 printed on a front surface of the paper sheet 90, which has a rectangular shape having four vertices 90a, 90b, 90c, 90d. In FIG. 9B are depicted documents 104, 108 printed on a back surface of the paper sheet 90. FIG. 9C schematically shows the paper sheet 90 folded into two to form the booklet. The printed document 92 in FIG. 9A includes a company name field 93 recorded as “XX Co., Ltd”, a tour name field 94 recorded as “USA West Coast Winery Tour”, a customer name field 96 in which are recorded a reservation number, date of issue, and customer name, and a photograph 98 that is changed according to the travel destination. Furthermore, the document 100 is set with a company information field 102 recorded with information on the tour company. The document 104 of FIG. 9B includes an itinerary 106 and the document 108 is set with a travel information field 110 in accordance with the travel destination.

The documents 92, 106, 108 are created from a form including variable parts, the values of which can be changed according to the customer. Namely, the tour name field 94 and the photograph 98 of the document 92 correspond to variable parts having different filled in data depending on the travel destination and the customer name field 96 corresponds to the variable part set with values according to the customer. Furthermore, the itinerary 106 of the document 104 corresponds to the variable part in which data changes depending on the tour destination and optional tour destination and the travel information field 110 of the document 108 corresponds to the variable part in which data changes depending on the travel destination. Then, a search is performed for the appropriate data, the digital document is created as print data by substituting the data into the variable parts, and the documents 92, 106, 108 are printed. In comparison, the document 100 is handled as a digital document that is printed directly with a form created only from a fixed part.

To print the four documents 92, 100, 106, 108 onto the paper sheet 90 and create the travel pamphlet, 2-up printing may be performed in a booklet format on both surfaces of the paper sheet 90. However, since print commands, such as double-sided printing or N-up printing, are analyzed and then executed at the printer, there is a risk of an unexpected printing discrepancy occurring at the time of the command depending on the printer specifications. Thus, data corresponding to the variable parts is extracted from the scan of the printed result and the printing of the four documents on the same paper sheet 90 is inspected for appropriate layout order and orientation. If there are no variable parts such as in the document 100, the entire document may be inspected or the inspection may be omitted due to the fixed printing. Furthermore, regarding the photograph 98 of the document 92, for example, confirming a detailed match with the print data lowers the inspection efficiency. An inspection extracting and comparing only a part of the photograph 98 is effective. On the other hand, for example, for the customer name field 96 of the same document 92, the printing of every word and phrase must not be smudged. For the overall variable parts, studying the validity of the OCR-processed data becomes effective.

Various embodiments are summarized hereinafter. It should be noted that some embodiments may overlap with the descriptions hereinbefore.

In one mode of the embodiment, the print management apparatus can be constructed using hardware having a computing function and software defining its operation. More specifically, a workstation or a personal computer can be used, and in this case the image forming device for printing and an image scanning device for scanning a printed result can be directly connected or arranged to allow communications over a network. Naturally, the workstation or the personal computer may be integrated with the image forming device and the image scanning device into a system that functions as a whole as a print management apparatus. Furthermore, the print management apparatus may be constructed using a multifunction device that includes an internal image forming device and image scanning device.

The print command unit executes printing by transmitting print command data to an image forming device, such as a printer, or its controller. The print command data is for performing print command and control and includes information specifying the print data to be used and print control information, such as paper sheet size, double-sided or single-sided, enlargement or reduction, rotation or inversion, N-up, and so forth. Printing is performed on the basis of the print data. The print data electronically expresses characters and graphics to be printed and may be expressed in a raster format or a vector format. The print data may be transmitted together with the print command data or may be set so as to be acquired separately by the image forming device.

The acquisition unit acquires the scan data generated in the image scanning device, such as a scanner. The scan data is generated by scanning at least part of the paper sheet on which the print image has been printed and is typically described in a raster format but may be described in another format, such as a vector format. The scan data is used in the inspection of the print image and is normally generated with the intention of including at least part of the print image.

The setting unit sets part of the print image as an inspection area on the basis of the print data. Namely, the inspection area is set as a partial area and not the entire area of the printed paper sheet. The inspection unit then compares the scan data and the print data in this inspection area and inspects for printing discrepancies. A printing discrepancy refers to a print image that differs from an intended image and can be illustrated as a discrepancy in print position (includes print surface or print orientation), discrepancy in paper sheet, such as paper size or multiple sheet feed, discrepancy in image formation, such as faint or smudged print, and so forth. The data comparison can be performed in various ways. For example, the degree of matching in the raster format or the degree of matching in the vector format may be compared. If the inspection area is a blank print area (namely, an area where toner or ink is not applied at all), the inspection unit may inspect that a print image has not been formed. However, in actuality, this inspection can be said to compare the inspection area with the print data.

Since the print inspection area is narrowed down according to this configuration, the inspection can be performed rapidly and at high accuracy. In particular, the effect can be further increased by setting an important area in terms of inspection as the inspection area. If a discrepancy is detected, a post-process may be performed, for example, interrupting the printing and informing the user of the interruption by a visual or aural indication. Naturally, if a discrepancy is not detected, informing the user of this is also effective. Furthermore, the inspection results may be recorded into a log file.

In one mode of the print management apparatus, the print data is variable data that is substituted into a variable part of form data and the setting unit sets as an inspection area at least part of an area corresponding to the variable part of the form data. The form data is a template for creating a digital document or print data and determines the format of the digital document to be created. Furthermore, the variable part is an area into which variable data having an individually specific value is substituted when creating individual documents. The form data may be provided with one or more variable parts. The variable data to be substituted is typically characters or numerals but may be images or audio. When print data is generated using form data having variable parts, variable printing becomes possible where variable data is changed for every page or every multiple pages. In variable printing, the inspection for printing discrepancies is generally difficult. However, by adopting this mode having an area corresponding to the variable part as the inspection area, the inspection of the printed result can be executed precisely.

In one mode of the print management apparatus, the setting unit selects and sets part of an area corresponding to the variable part as an inspection area on the basis of variable part characteristics or variable data characteristics. Although the variable part is an area where it is highly necessary to inspect for discrepancies, it is not always necessary to inspect the entire area. For example, if the variable data is a large image or a long sentence, there are instances where the correctness of the print position can be inspected or the data can be inspected to confirm it has not be replaced with other variable data without inspecting the variable data in its entirety. Furthermore, if the variable data does not always change and changes occasionally, the inspection may be performed only around the time of the change. Or, if there are variable parts on the same page, inspecting only a part can confirm that the print position of the page is valid. Thus, the variable part included in the inspection area was determined on the basis of the variable part characteristics or the variable data characteristics. The variable part characteristics refer to the characteristics that are derived from set information regarding the variable part and the variable data characteristics refer to the characteristics that are obtained from the variable data. More specifically, various examples can be given, such as the variable data that is input into the variable part is an image or character, is in color or monochrome, occupies a space having a certain size, has a certain font size, is changed at a certain frequency, and so forth.

In one mode of the print management apparatus, the setting unit set an inspection area on the basis of the print command data. Furthermore, in one mode of the print management apparatus, the print. command unit transmits print command data to execute double-sided printing or N-up printing and the inspection unit inspects for discrepancies the position where the print image has been printed. If the print position and print size are controlled by the print command data, an appropriate inspection area cannot be set simply on the basis of the print data. Furthermore, although the operation of the image forming device is based on the print command data, the print management apparatus may perform in a manner differing from what is expected due to some reason. In particular, it is necessary to exercise care in impositioning in double-sided printing or laying out pages in N-up printing. Thus, it is important to set an appropriate inspection area on the basis of the print command data.

In one mode of the print management apparatus, the inspection unit inspects for printing discrepancies by comparing the OCR-processed result for the scan data with the print data. Namely, inspection for printing discrepancies is performed by comparing the scan data, which has been converted to character codes by OCR processing, with the character codes within the print data. The OCR function may be provided within the scanning device. Generally, although the recognition accuracy in OCR processing is not always perfect, it is possible to improve the recognition accuracy if the value that should be scanned is guessed by referencing the print data and raise the inspection reliability.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print management apparatus comprising:
a print command unit that transmits print command data and prints a print image onto a paper sheet on the basis of print data;
an acquisition unit that acquires generated scan data from a scan of the paper sheet printed with the print image;
a setting unit that sets a part of the print image as an inspection area on the basis of the print data; and
an inspection unit that inspects for printing discrepancies by comparing the scan data and the print data in the set inspection area.

2. A print management apparatus according to claim 1, wherein:
the print data is variable data that is substituted into a variable part of form data; and
the setting unit sets as an inspection area at least part of an area corresponding to the variable part of the form data.

3. A print management apparatus according to claim 2, wherein:
the setting unit selects and sets as an inspection area a part of an area corresponding to the variable part on the basis of variable part characteristics or variable data characteristics.

4. A print management apparatus according to claim 1, wherein:
the setting unit sets an inspection area on the basis also of the print command data.

5. A print management apparatus according to claim 4, wherein:
the print command unit transmits a print command data to execute double-sided printing or N-up printing; and
the inspection unit inspects for discrepancies. in the position where the print image has been printed.

6. A print management apparatus according to claim 1, wherein:
the inspection unit inspects for printing discrepancies by comparing an OCR-processed result for the scan data with the print data.

7. A storage medium readable by a computer, the storage medium storing a program of instructions executable by the computer to perform a print management process, the process comprising:
performing a command to transmit a print command data and print a print image onto a paper sheet on the basis of print data;
acquiring scan data generated from a scan of the paper sheet on which is printed the print image;
setting a part of the print image as an inspection area on the basis of the print data; and
inspecting for print discrepancies by comparing the scan data and the print data in the set inspection area.

8. A storage medium according to claim 7, wherein:
the print data is variable data that is substituted into a variable part of form data; and
in the setting of the inspection area, at least part of an area corresponding to the variable part of form data is set as the inspection area.

9. A storage medium according to claim 8, wherein:
in the setting of the inspection area, part of an area corresponding to the variable part is selected and set as the inspection area on the basis of variable part characteristics or variable data characteristics.

10. A storage medium according to claim 7, wherein:
in the setting of the inspection area, the inspection area is set on the basis also of print command data.

11. A storage medium according to claim 10, wherein:
in the print command, print command data is transmitted to execute double-sided printing or N-up printing; and
in the inspection for printing discrepancies, an inspection is performed for discrepancies in the position where the print image has been printed.

12. A storage medium according to claim 1, wherein:
in the inspection for printing discrepancies, an inspection is performed for printing discrepancies by comparing an OCR-processed result for the scan data with the print data.

13. A print management method comprising:
executing a command to transmit print command data and print a print image onto a paper sheet on the basis of print data;
acquiring scan data generated from a scan of the paper sheet on which is printed the print image;
setting at least part of a print image on the basis of print data; and
inspecting for printing discrepancies by comparing the scan data and the print data in the set inspection area.

14. A print management method according to claim 13, wherein:
the print data is variable data substituted into the variable part of form data; and
in the setting of the inspection area, at least part of an area corresponding to the variable part of form data is set as the inspection area.

15. A print management method according to claim 14, wherein:
in the setting of the inspection area, part of an area corresponding to the variable part is selected and set as the inspection area on the basis of variable part characteristics or variable data characteristics.

16. A print management method according to claim 13, wherein:
in the setting of the inspection area, the inspection area is set on the basis of the print command data.

17. A print management method according to claim 16, wherein:
in the print command, the print command data for executing double-sided printing or N-up printing is transmitted; and
in the inspection for printing discrepancies, the position where the print image has been printed is inspected for discrepancies.

18. A print management method according to claim 13, wherein:
in the inspection for printing discrepancies, the OCR-processed result for the scan data is compared with the print data to inspect for printing discrepancies.
